(19) United States
(12) Patent Application Publication
(10) Pub. No.: US 2018/0121025 A1
(43) Pub. Date: May 3, 2018

(54) DYNAMIC ENRICHMENT OF COMMUNICATION ITEMS

(71) Applicant: Microsoft Technology Licensing, LLC., Redmond, WA (US)

(72) Inventors: Roshin Lal Ramesan, Redmond, WA (US); Megan Marie Quintero, Seattle, WA (US); Michael Francis Palermiti, II, Sammamish, WA (US)

(73) Assignee: Microsoft Technology Licensing, LLC., Redmond, WA (US)

(21) Appl. No.: 15/336,699

(22) Filed: Oct. 27, 2016

(51) Int. Cl. G06F 3/0481; H04L 12/58; G06F 17/27; G06F 17/21; G06F 17/30; G06N 99/00

(52) U.S. Cl. CPC G06F 3/0481; H04L 51/22; G06F 17/2705; G06N 99/005; G06F 17/211; G06F 17/30864; G06F 17/278

(57) ABSTRACT

Improving content descriptions and interaction efficiency by the dynamic enrichment of communication items is disclosed herein. A communication enrichment system receives a communication item, such as an email, for display within an application user interface. The system extracts enrichment details from the communication items. The communication enrichment system utilizes the enrichment details for querying one or more data sources and obtains any enrichment items relating to the enrichment details. Further, the communications items are modified to include the enrichment items to provide additional information, actions, functionality, or visual identifies to provide an enriched user interface. Accordingly, the communication enrichment system improves the efficiency of the communication client to visually identify the substance of the communication item and execute/perform any functionality associated with a communication item without opening the communication item.

### BACKGROUND

Computer users typically utilize messaging applications throughout the day. Messaging applications provide many advantages for communicating electronically with another entity or person. Typically, the communications include sender information, addressee information, subject information, a communication body, and any attachments. These messaging applications generally include a listing of communication items that each identifies the sender, the subject information, and the first line of the communication body. However, this information is static and does not reflect the current context. Further, the information in the listing of communication items merely reflects textual information that was entered by another person. The substance of the textual information may or may not be accurate. In order to determine the substance of the communication item, a user typically is required to open and review each communication item.

### SUMMARY

This summary is provided to introduce a selection of concepts in a simplified form that are further described below in the Detailed Description section. This summary is not intended to identify all key or essential features of the claimed subject matter, nor is it intended as an aid in determining the scope of the claimed subject matter.

Aspects of the present disclosure are directed to a method, system, and computer readable medium for improving content descriptions and interaction efficiency by the dynamic enrichment of communication items. The communication enrichment system receives a communication item, such as an email, for display within an application user interface. The system extracts enrichment details from the communication items. The communication enrichment system utilizes the enrichment details for querying one or more data sources and obtains any enrichment items relating to the enrichment details. Further, the communications items are modified to include the enrichment items to provide additional information, actions, functionality, or visual identifiers to provide an enriched user interface. In one example, the enriched user interface displays enrichment items that reflect the current state of the communication item. Thus, the user is provided with up-to-date information rather than static information that may or may not be relevant to the current time frame. Accordingly, the communication enrichment system improves the efficiency of the communication client to visually identify the substance of the communication item and execute/perform any functionality associated with a communication item without opening the communication item.

Examples are implemented as a computer process, a computing system, or as an article of manufacture such as a device, computer program product, or computer readable medium. According to an aspect, the computer program product is a computer storage medium readable by a computer system and encoding a computer program comprising instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 is a block diagram of a representation of an environment for providing dynamic enrichment of communication items;

FIG. 2A is an illustration of an example graphical user interface in which dynamic enrichment of communication items is implemented;

FIG. 2B is an illustration of an example graphical user interface in which dynamic enrichment of communication items is not implemented;

FIG. 3 is an illustration of an example graphical user interface in which dynamic enrichment of communication items is implemented;

FIG. 4 is a flow chart showing general stages involved in an example method for dynamic enrichment of communication items;

FIG. 5 is a block diagram illustrating example physical components of a computing device;

FIGS. 6A and 6B are block diagrams of a mobile computing device; and

FIG. 7 is a block diagram of a distributed computing system.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

Aspects of the present disclosure are directed to a method, system, and computer readable medium for improving content descriptions and interaction efficiency by the dynamic enrichment of communication items. The communication enrichment system receives a communication item, such as an email, for display within an application user interface. The system extracts enrichment details from the communication items. The communication enrichment system utilizes the enrichment details for querying one or more data sources and obtains any enrichment items relating to the enrichment details. Further, the communications items are modified to include the enrichment items to provide additional information, actions, functionality, or visual identifiers to provide an enriched user interface. Accordingly, the communication enrichment system improves the efficiency of the communication client to visually identify the substance of the communication item and execute/perform any functionality associated with a communication item without opening the communication item.

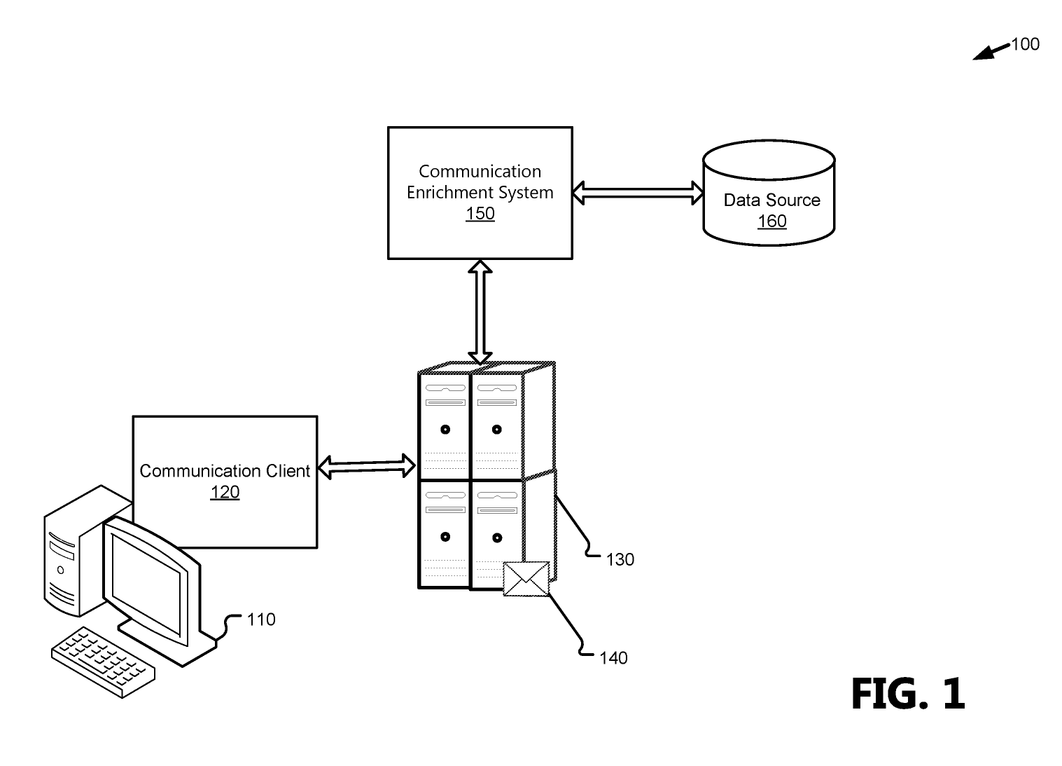

FIG. 1 is a block diagram of a representative computing environment 100 for providing dynamic enrichment of communication items. As illustrated, the example environment includes a computing device 110, on which is running a communication client 120. The communication client 120 communicates with a communication service 130 to send and receive communication items 140. Various email servers and intermediaries may lie between the computing device 110 and the communication service 130 to route the communication items 140.

The communication service 130 communicates with a communication enrichment system 150 to provide enrichment of communication items 140. Examples of the communication service 130 include, but are not limited to: Outlook® (available from Microsoft, Corp. of Redmond, Wash.), Gmail™ (available from Alphabet, Inc. of Mountain View, Calif.), and Mail (available from Apple, Inc. of Cupertino, Calif.). Such productivity applications may store content items locally or in the cloud via cloud storage solutions, such as, for example, Google Drive™ or OneDrive® (available from Alphabet, Inc. and Microsoft, Corp., respectively).

The communication enrichment system 150 is configured to receive communications items and extract enrichment details from the communication items 140. The enrichment details including keywords, phrases, links, subject, message body, contact information, and entity. The communication enrichment system 150 utilizes the enrichment details for querying one or more data sources 160 for related enrichment items. The communication enrichment system 150 obtains the enrichment items from the data sources 160. Thereafter the communication enrichment system 150 modifies the communications items with the enrichment items for display at the communication client 120 to provide additional information, actions, functionality, or visual identifiers to provide an enriched user interface. Furthermore, the communication enrichment system 150 is configured to monitor the enrichment items for changes, such that the communication enrichment system 150 dynamically updates the enrichment items to reflect the latest context.

While the communication enrichment system 150 is shown remotely from the communication service 130 for illustrative purposes, it should be noted that the communication enrichment system 150 is suitable in several configurations including, without limitation, a separate system hosted by the communication service 130, an integral aspect of the communication service 130, or a remote server.

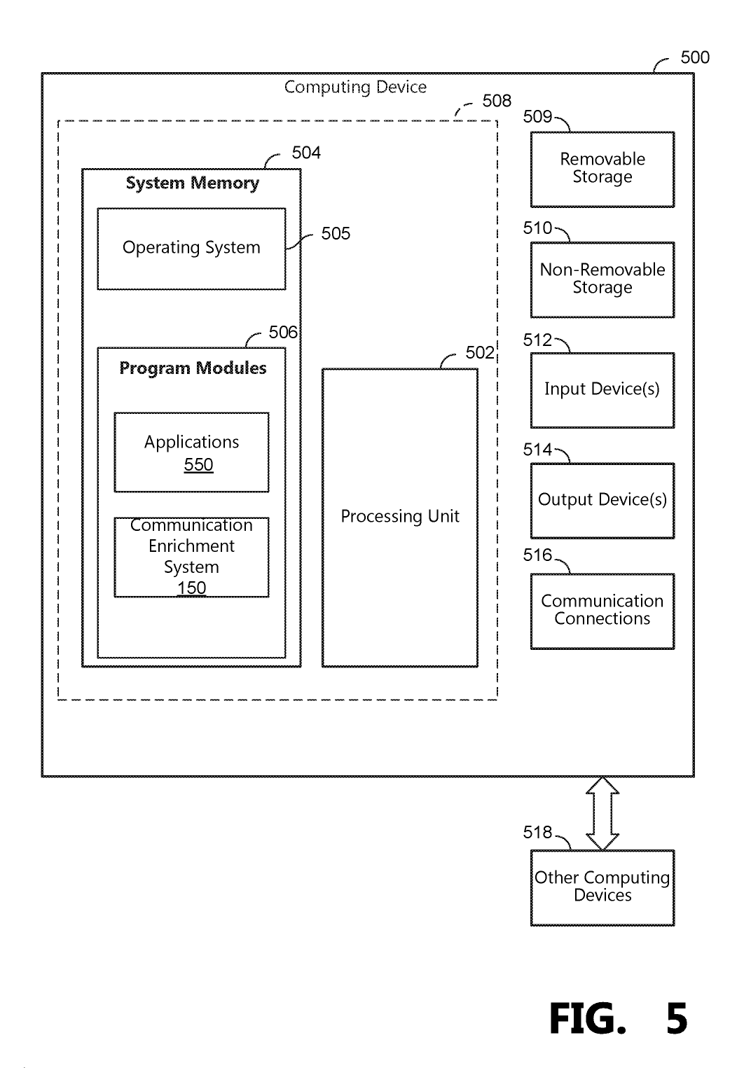

The computing device 110 is illustrative of a variety of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers. The hardware of these computing systems is discussed in greater detail in regard to FIGS. 5, 6A, 6B, and 7. In various aspects, the computing device 110 is accessible locally and/or by a network, which may include the Internet, a Local Area Network (LAN), a private distributed network for an entity (e.g., a company, a university, a government agency), a wireless ad hoc network, a Virtual Private Network (VPN) or other direct data link (e.g., Bluetooth connection, a direct wired link).

The communication client 120 used to send and receive the communication items 140 is illustrative of a productivity application used to send and receive communication items 140, including, without limitation, local applications and cloud-based applications, such as for example: Outlook® (available from Microsoft, Corp. of Redmond, Wash.), Gmail™ (available from Alphabet, Inc. of Mountain View, Calif.), and Mail (available from Apple, Inc. of Cupertino, Calif.).

The communication item 140 may be composed, formatted, transmitted, and received according to various standards (and various versions thereof), including, but not limited to: POP (Post Office Protocol), IMAP (Internet Message Access Protocol), MIME (Multipurpose Internet Mail Extension), SMTP (Simple Mail Transfer Protocol), HTML (Hypertext Markup Language), Rich Text, Plain Text, etc.

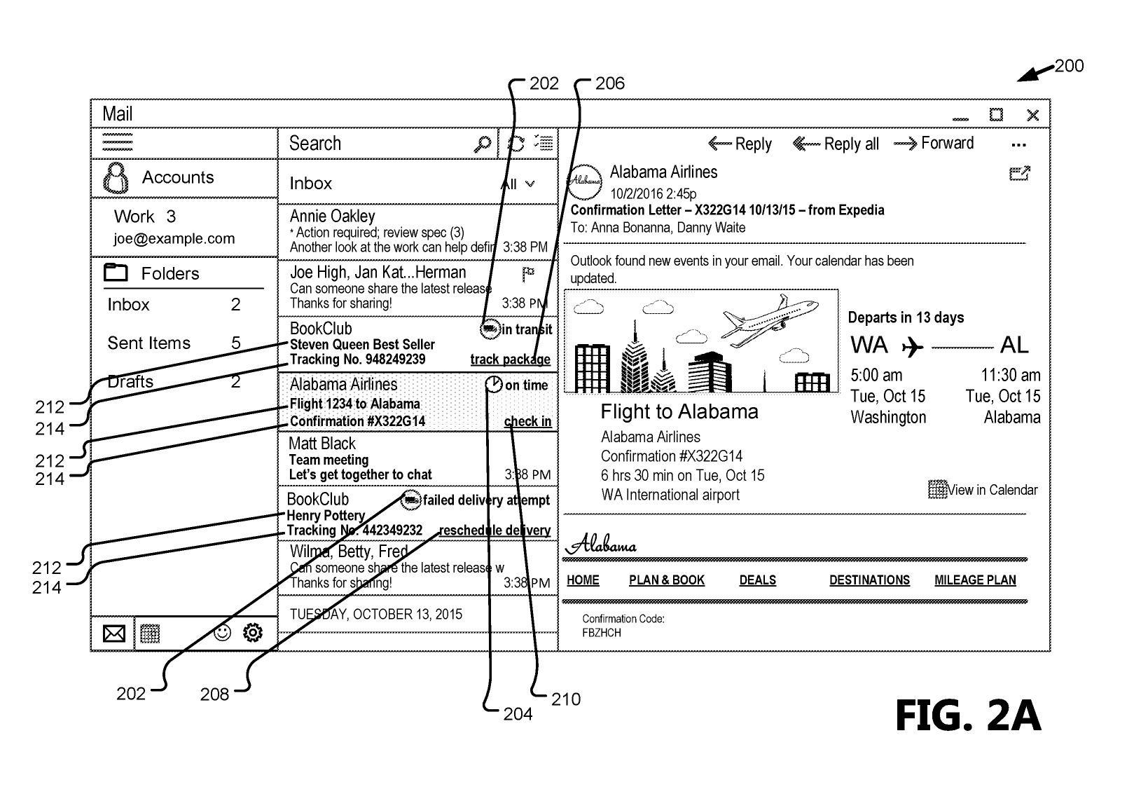

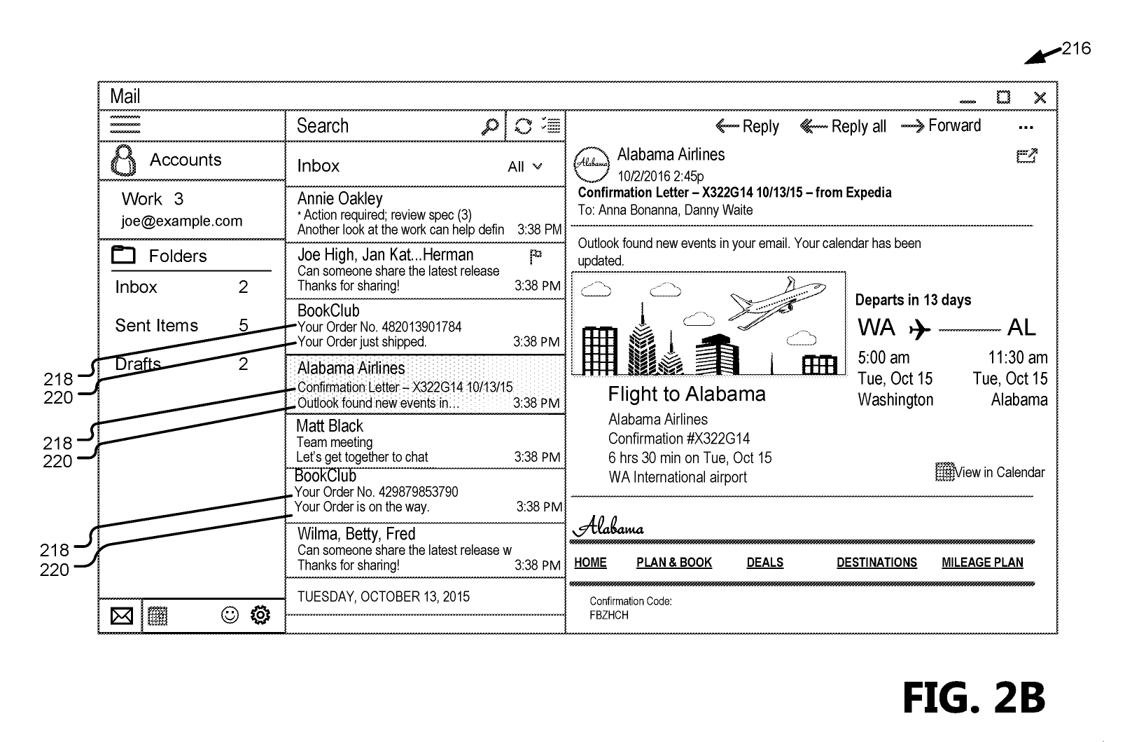

FIG. 2A illustrates aspects of dynamic enrichment of communication items 140 including an example user interface 200 for a communication client 120. As will be appreciated, the user interfaces illustrated and discussed are explanatory, and do not limit the scope of the present disclosure in the inclusion or exclusion of discussion of various components.

As illustrated, the user interface 200 is example of a user interface provided on the communication client 120. The illustrated user interface 200 includes various controls for interacting with the communication item 140. Further, user interface 200 includes various enrichment items provided throughout the display.

According to one aspect, the user interface 200 includes an enrichment item including an indicator relating to the communication item. More specifically, the user interface 200 includes an enrichment icon. The enrichment icon provides a representation of a summary of the communication, intent of the communication item, or otherwise visually identifies the substance of the communication item without opening the communication item. Accordingly, a user can visually inspect the communication list to distinguish between the subject matter of each of the communication items 140. In the illustrated example, the communication items 140 include a first enrichment icon 202 that displays a delivery truck, which identifies that the communication is related to shipping. In the illustrated example, the content items include a second enrichment icon 204 that displays a clock associated with a communication from an airline, which provides an indication that the flight is “on time.” Further, the second enrichment icon 204 may display a green clock or green text when the flight is “on time,” a yellow clock or yellow text when the flight is “delayed,” and a red clock or red text when the flight is “cancelled.”

According to another aspect, the user interface 200 includes an enrichment item including a functionality relating to the communication item. More specifically, the user interface 200 includes a control or link to perform the functionality. Accordingly, a user can easily identify and execute/perform the functionality without opening the communication item. In the illustrated example, the communication items 140 include a first enrichment control 206 that provides functionality to track the delivery. Further, in the illustrated example, the communication items 140 include a second enrichment control 208 that provides functionality to reschedule the delivery. Additionally, in the illustrated example, the communication items 140 include a third enrichment control 210 that provides functionality to check-in to the flight. As noted above, the enrichment control is configured to perform the functionality directly from the user interface 200.

According to another aspect, the user interface 200 includes enrichment item including textual information. More specifically, the user interface 200 replaces selected textual information concerning the communication item with more digestible textual information. In one example, the enrichment item includes an enriched summary 212 of the communication item that reflects the intent of the communication item. In another example, the enrichment item includes an enriched preview 214 of the communication item that reflects a brief description of the communication item based on the intent of the communication item. Accordingly, the standard summary description and/or the standard preview of the communication are modified to provide enrichment items based on the intent of the communication item.

FIG. 2B is an illustration of an example graphical user interface 216 in which the communication items are implemented using static information. More specifically, the example graphical user interface shows a default summary 218 that includes the subject identified in the message. Further, the default preview 220 of the message merely repeats the first few words of the message body. Accordingly, the message from “BookClub” that states “Your Order No. 482013901784” or “Your Order just shipped” provides very little information about the intent of the communication item. In contrast, in FIG. 2A, the message from “Book Club” clearly identifies that the communication item relates to “Steven Queen Best Seller” in the enriched subject area and provides the tracking number in the enriched preview area. Thus, the user is able to quickly determine the intent and subject of the communication item more efficiently based on the enriched summary 212 and the enriched preview 214.

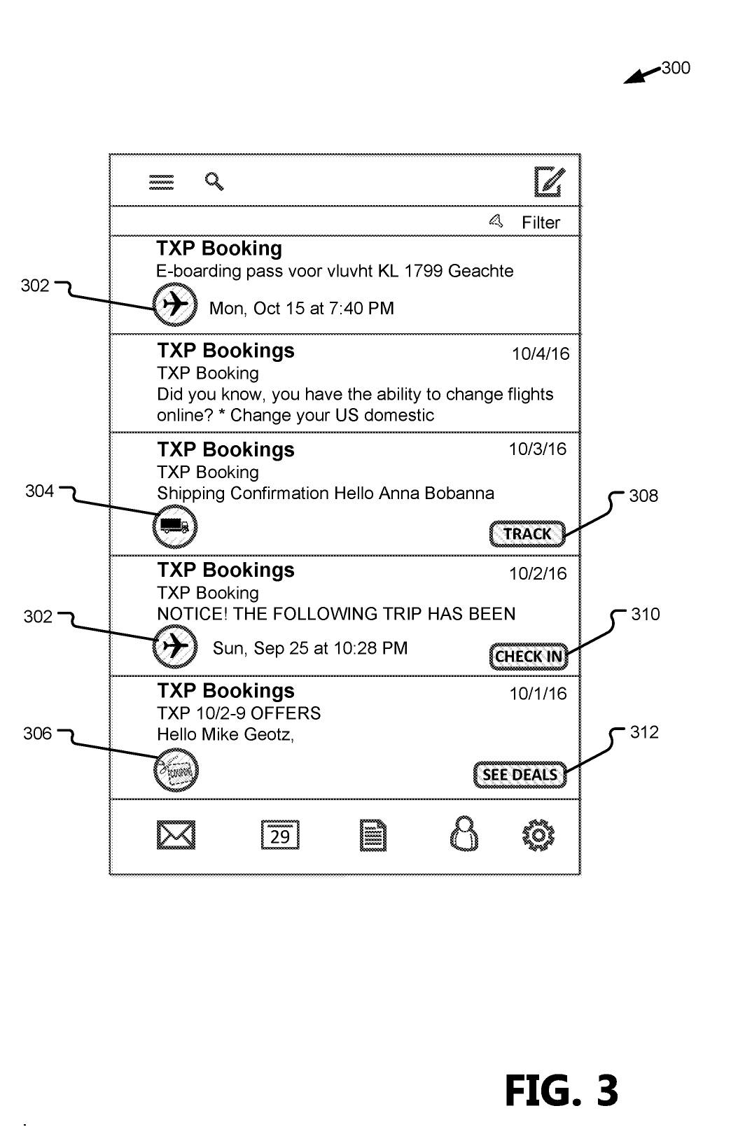

FIG. 3 illustrates aspects of dynamic enrichment of communication items 140 including an example user interface 300 for a communication client 120. As will be appreciated, the user interfaces illustrated and discussed are explanatory, and do not limit the scope of the present disclosure in the inclusion or exclusion of discussion of various components. As illustrated, the user interface 300 is example of a user interface provided on the communication client 120. The illustrated user interface 300 includes various enrichment items provided throughout the display.

According to one aspect, the user interface 300 includes enrichment item including an indicator relating to the communication item. More specifically, the user interface 300 includes an enrichment icon. The enrichment icon provides a representation of a summary of the communication, intent of the communication item, or otherwise visually identifies the substance of the communication item without opening the communication item. Accordingly, a user can visually inspect the communication list to distinguish between the subject matter of each of the communication items 140. In the illustrated example, the communication items 140 include a first enrichment icon 302 that displays an airplane, which provides a visual representation that the communication item relates to travel. The communication items 140 also include a second enrichment icon 304 that displays a delivery truck, which provides a visual representation that the communication item relates to shipping. The communication items 140 further include a third enrichment icon 306 that displays a coupon clipping, which provides a visual representation that the communication item relates to promotional information.

According to another aspect, the user interface 300 includes an enrichment item including a functionality relating to the communication item. More specifically, the user interface 300 includes an enrichment control to initiate or perform the functionality. Accordingly, a user can easily identify and execute/perform the functionality without opening the communication item. In the illustrated user interface 300, the communication items 140 include a first enrichment control 308 that provides functionality to track the delivery. Further, in the illustrated user interface 300, the communication items 140 include a second enrichment control 310 that provides functionality to check-in to the flight. Additionally, in the illustrated user interface 300, the communication items 140 include a third enrichment control 312 that provides functionality to see the promotional information. As noted above, the enrichment control is configured to perform the functionality directly from the user interface 300.

According to another aspect, the user interface 300 includes enrichment item that are dynamically added, removed or updated. As the context of the enrichment item changes, the computing device dynamically modifies the enrichment item. For example, after the user has checked into their flight, the enrichment item displayed in the user interface 300 may be removed or updated to reflect the flight status of the flight.

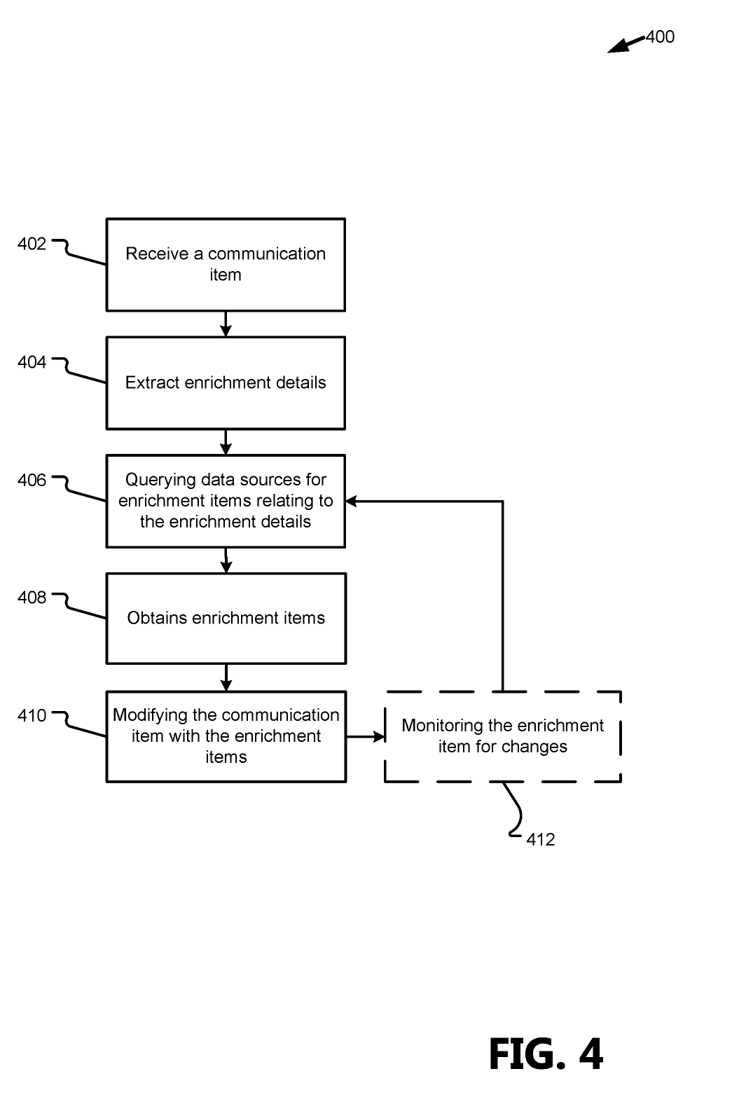

FIG. 4 is a flow chart showing general stages involved in an example method for dynamic enrichment of communication items 140.

The method 400 begins at start OPERATION 402, where the computing system receives a communication item. In one example, the computing system receives an email message to be displayed. In another example, the computing system receives a calendar item. In other examples, the computing system receives other types of communication items 140 associated with a productivity application.

The method 400 continues to OPERATION 404, where the computing system extracts enrichment details from the communication item. According to one aspect, the computing system extracts various meaningful facts from the communication item. In one example, the computing device parses the communication item for keywords, phrases, links, subject, message body, contact information, etc. In another example, the computing device parses the attachments of the communication item. According to one aspect, the computing system determines an entity associated with the communication item. Specifically, the computing system is operable to extract entity information directly from the communication item, extract the entity information using template-based models, or extract the entity information using machine learning models. In one example, the communication item is organized in accordance with a predefined structure associated with the communication item. More specifically, the entity information associated with the communication item identifies an intent, communication type, or organization. In various examples, the entity information associated with the communication item identifies promotion information (such as a coupon), tracking information, or flight information. The enrichment details extracted by the template-based models or the machine learning models may identify flight reservations, confirmation number, seat assignment, etc., at a specified location within the communication item, which are identified as entities configurable to be enriched.

The method 400 continues to OPERATION 406, where the computing system queries one or more data sources 160 for enrichment items relating to the enrichment details. Specifically, the computing system queries one or more data sources 160 for enrichment items relating to the enrichment details. In one example, the enrichment items identify an intent relating to the communication item, including an understanding of the motive, purpose, reason of the communication item. The queries may be performed by the computing system or multiple computing systems. For example, the queries may be performed client-side, server-side or a combination of client-side and server-side. Further, the computing system may perform the queries of local data sources or external data sources. In accordance with aspects, the queries may be performed utilizing a search engine, a knowledge graph or a database. Additionally, the queries may be based on inferences relating to the queries. For example, if the entity is a city, restaurant, etc., then the computing system may infer other related information such as a specific location, tracking information, coupon information, a time zone, an airline information, etc. Additionally, the computing system may infer relationships between other communications or events within the user's communications and calendar applications (e.g., email items, calendar items, task items, etc.) that are utilized to enrich the context. The other related information may be utilized to provide additional results that relate to the entity. According to another aspect, the computing system queries one or more data sources 160 for context relating to the communication item. For example, the computing system may retrieve information relating to the user's communications, calendar events, location, time zone, etc., in order to provide relevant contextual information that is applicable to a particular communication item.

The method 400 continues to OPERATION 408, where the computing system obtains enrichment items. More specifically, the computing system obtains the enrichment items based on the enrichment details and/or enrichments items located in querying the one or more data sources 160. According to one aspect, the computing system retrieves the most relevant enrichment items from the one or more data sources 160. In one example, the computing system identifies enrichment items based on mapping the enrichment details to the contextual information. For example, based on the relevant contextual information, the computing system analyzes the relevance of the entities to the enrichment items. In one example, the computing system utilizes a knowledge graph to determine the enrichment items relative in order to provide the most relevant enrichment item based on the contextual information. In one example, the enrichment item identifies a communication type such as promotion information (such as a coupon or a sale), dining information, shipping/tracking information, or flight information.

According to another aspect, the computing system obtains the enrichment items including textual information relating to the communication item. More specifically, the textual information provided by the enrichment items is based on the intent of the communication item and one or more of the keywords, the phrases, the links, or the contact information parsed from the communication item. In one example, machine learning models process the keywords, the phrases, the links, or the contact information parsed from the communication item and generates the textual information relating to the communication item. In one example, the textual information provided by the enrichment items includes an enriched summary of the communication item that reflects the intent of the communication item. In one example, the textual information provided by the enrichment items includes an enriched preview of the communication item that reflects a brief description of the communication item based on the intent of the communication item.

According to yet another aspect, the enrichment item identifies one or more actions or functionalities relating to the communication item. Machine learning models may process the enrichment details to identify one or more actions or functionalities relating to the communication item. In one example, the enrichment items relate to actions associated with promotion information. The enrichment items may provide actions, such as a link, to see additional details relating to the promotion, such as sale information, coupon information, sale duration/expiration date (i.e., “expiring soon” or “expires at midnight”) or other type of promotion information. In another example, the enrichment items relate to actions associated with dining information. The enrichment items may provide actions, such as a link, to see additional details relating to the dining, such as reservation information, reviews information, or other type of dining information. In yet another example, the enrichment items that relate to tracking information include actions associated with shipping/tracking information. The enrichment items may provide actions, such as a link, to see additional details relating to the tracking, such as the shipping status, tracking information, rescheduling information, or other type of tracking information. In another example, the enrichment items that relate to travel information include actions associated with flight information. The enrichment items may provide actions, such as a link, to see additional details relating to the flight, such as flight status, reservation information, check-in information, or other type of flight information.

The method 400 continues to OPERATION 410, where the computing system modifies the communication item with the enrichment items. More specifically, the communication items 140 are modified with the enrichment items to provide additional information, actions, functionality, or visual identifies to provide an enriched user interface. Thus, the enrichment items provide an organized and enriched view of the communications items. In other words, communication items 140 within the message list may be tailored to reflect the intent of the communication.

According to one aspect, the computing system modifies the communication item with enrichment item including an indicator relating to the communication item. In another example, the enrichment items are provided as a notification in the user interface. In another example, the enrichment items are provided as an enrichment icon. The enrichment icon provides a representation of a summary of the communication, intent of the communication item, or otherwise visually identifies the substance of the communication item. Accordingly, a user can visually inspect the communication list to distinguishing between the subject matter of each of the communication items 140.

According to another aspect, the computing system modifies the communication item with an enrichment item including one or more actions or functionalities. More particularly, the enrichment items include controls or links that provide additional functionality relating to the communication item. In one example, a communication item relating to flight information includes enrichment items that provide functionality to request flight status, check-in, upgrade seats, change seats, cancel reservations, etc. In another example, a communication item relating to tracking information includes enrichment items that provide functionality to request shipping status, track the delivery, reschedule the delivery, etc. In another example, a communication item relating to promotion information includes enrichment items that provide functionality to display coupons, display information relating to the promotion, etc. In another example, a communication item relating to dining information includes enrichment items that provide functionality to schedule reservation, cancel a reservation, view restaurant menus, etc.

According to yet another aspect, the computing system modifies the communication item with an enrichment item including textual information. In one example, the enrichment item includes an enriched summary of the communication item that reflects the intent of the communication item. In another example, the enrichment item includes an enriched preview of the communication item that reflects a brief description of the communication item based on the intent of the communication item. Accordingly, the standard summary description and/or the standard preview of the communication are modified to provide enrichment items based on the intent of the communication item.

The method 400 continues to optional OPERATION 412, where the computing system monitors the enrichment items for changes. More specifically, the computing system monitors the enrichment details, communication items 140, or the enrichment items to determine whether a change has occurred. When a change has occurred, the computing system dynamically updates the enrichment item. In one example, the method returns to OPERATION 406 to provide the dynamic update to the enrichment item. Thus, the method 400 provides for real-time status updates relating to the communication item.

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 5-7 and the associated descriptions provide a discussion of a variety of operating environments in which examples are practiced. However, the devices and systems illustrated and discussed with respect to FIGS. 5-7 are for purposes of example and illustration and are not limiting of a vast number of computing device configurations that are utilized for practicing aspects, described herein.

FIG. 5 is a block diagram illustrating physical components (i.e., hardware) of a computing device 500 with which examples of the present disclosure may be practiced. In a basic configuration, the computing device 500 includes at least one processing unit 502 and a system memory 504. According to an aspect, depending on the configuration and type of computing device, the system memory 504 comprises, but is not limited to, volatile storage (e.g., random access memory), non-volatile storage (e.g., read-only memory), flash memory, or any combination of such memories. According to an aspect, the system memory 504 includes an operating system 505 and one or more program modules 506 suitable for running software applications 550. According to an aspect, the system memory 504 includes communication enrichment system 150. The operating system 505, for example, is suitable for controlling the operation of the computing device 500. Furthermore, aspects are practiced in conjunction with a graphics library, other operating systems, or any other application program, and are not limited to any particular application or system. This basic configuration is illustrated in FIG. 5 by those components within a dashed line 508. According to an aspect, the computing device 500 has additional features or functionality. For example, according to an aspect, the computing device 500 includes additional data storage devices (removable and/or non-removable) such as, for example, magnetic disks, optical disks, or tape. Such additional storage is illustrated in FIG. 5 by a removable storage device 509 and a non-removable storage device 510.

As stated above, according to an aspect, a number of program modules and data files are stored in the system memory 504. While executing on the processing unit 502, the program modules 506 (e.g., communication enrichment system 150) perform processes including, but not limited to, one or more of the stages of the method 400 illustrated in FIG. 4. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, aspects are practiced in an electrical circuit comprising discrete electronic elements, packaged or integrated electronic chips containing logic gates, a circuit utilizing a microprocessor, or on a single chip containing electronic elements or microprocessors. For example, aspects are practiced via a system-on-a-chip (SOC) where each or many of the components illustrated in FIG. 5 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 500 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 500 has one or more input device(s) 512 such as a keyboard, a mouse, a pen, a sound input device, a touch input device, etc. The output device(s) 514 such as a display, speakers, a printer, etc. are also included according to an aspect. The aforementioned devices are examples and others may be used. According to an aspect, the computing device 500 includes one or more communication connections 516 allowing communications with other computing devices 518. Examples of suitable communication connections 516 include, but are not limited to, radio frequency (RF) transmitter, receiver, and/or transceiver circuitry; universal serial bus (USB), parallel, and/or serial ports.

The term computer readable media, as used herein, includes computer storage media. Computer storage media include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (i.e., memory storage.) According to an aspect, computer storage media include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. According to an aspect, any such computer storage media is part of the computing device 500. Computer storage media do not include a carrier wave or other propagated data signal.

According to an aspect, communication media are embodied by computer readable instructions, data structures, program modules, or other data in a modulated data signal, such as a carrier wave or other transport mechanism, and include any information delivery media. According to an aspect, the term “modulated data signal” describes a signal that has one or more characteristics set or changed in such a manner as to encode information in the signal. By way of example, and not limitation, communication media include wired media such as a wired network or direct-wired connection, and wireless media such as acoustic, radio frequency (RF), infrared, and other wireless media.

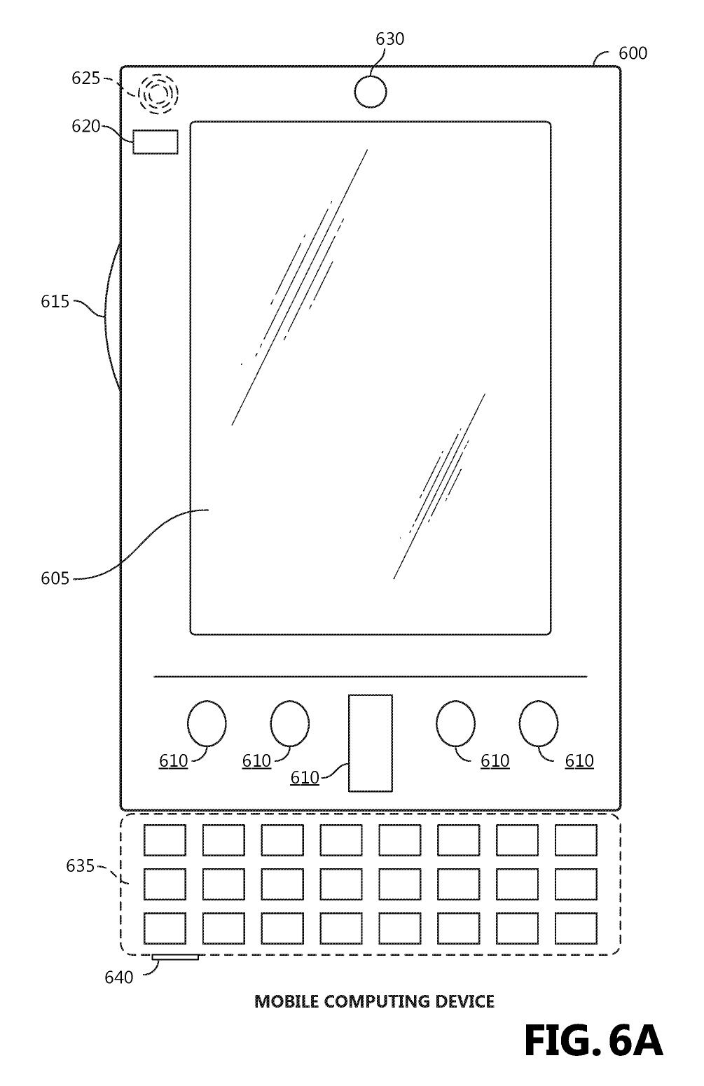

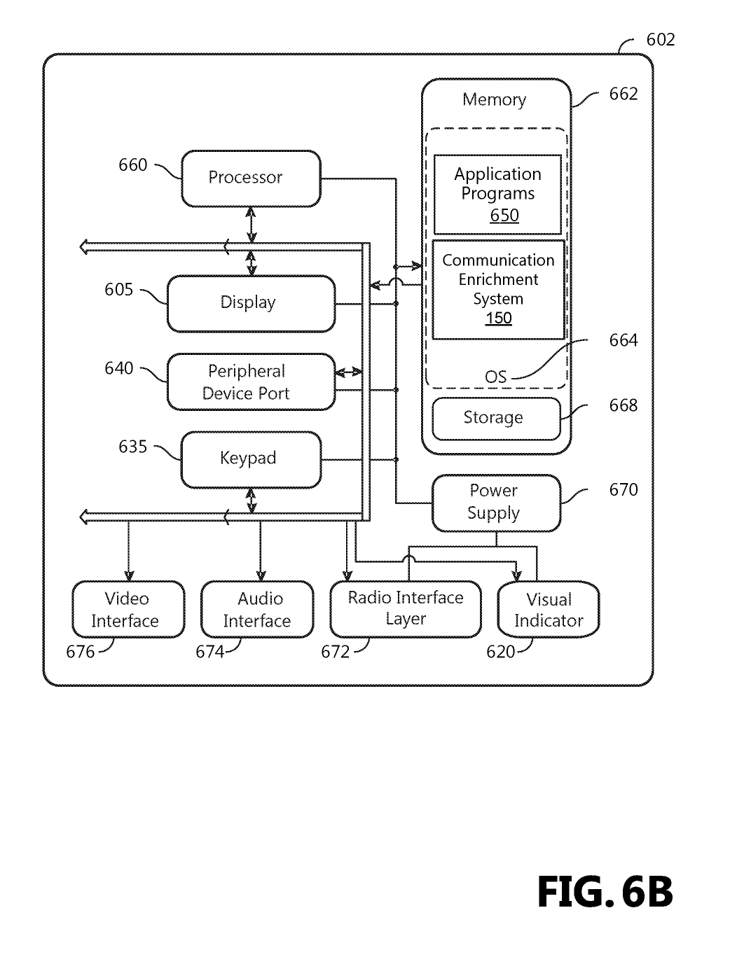

FIGS. 6A and 6B illustrate a mobile computing device 600, for example, a mobile telephone, a smart phone, a tablet personal computer, a laptop computer, and the like, with which aspects may be practiced. With reference to FIG. 6A, an example of a mobile computing device 600 for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. According to an aspect, the display 605 of the mobile computing device 600 functions as an input device (e.g., a touch screen display). If included, an optional side input element 615 allows further user input. According to an aspect, the side input element 615 is a rotary switch, a button, or any other type of manual input element. In alternative examples, mobile computing device 600 incorporates more or fewer input elements. For example, the display 605 may not be a touch screen in some examples. In alternative examples, the mobile computing device 600 is a portable phone system, such as a cellular phone. According to an aspect, the mobile computing device 600 includes an optional keypad 635. According to an aspect, the optional keypad 635 is a physical keypad. According to another aspect, the optional keypad 635 is a “soft” keypad generated on the touch screen display. In various aspects, the output elements include the display 605 for showing a graphical user interface (GUI), a visual indicator 620 (e.g., a light emitting diode), and/or an audio transducer 625 (e.g., a speaker). In some examples, the mobile computing device 600 incorporates a vibration transducer for providing the user with tactile feedback. In yet another example, the mobile computing device 600 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 600 incorporates peripheral device port 640, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one example of a mobile computing device. That is, the mobile computing device 600 incorporates a system (i.e., an architecture) 602 to implement some examples. In one example, the system 602 is implemented as a “smart phone” capable of running one or more applications (e.g., browser, e-mail, calendaring, contact managers, messaging clients, games, and media clients/players). In some examples, the system 602 is integrated as a computing device, such as an integrated personal digital assistant (PDA) and wireless phone.

According to an aspect, one or more application programs 650 are loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. According to an aspect, communication enrichment system 150 is loaded into memory 662. The system 602 also includes a non-volatile storage area 668 within the memory 662. The non-volatile storage area 668 is used to store persistent information that should not be lost if the system 602 is powered down. The application programs 650 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600.

According to an aspect, the system 602 has a power supply 670, which is implemented as one or more batteries. According to an aspect, the power supply 670 further includes an external power source, such as an AC adapter or a powered docking cradle that supplements or recharges the batteries.

According to an aspect, the system 602 includes a radio 672 that performs the function of transmitting and receiving radio frequency communications. The radio 672 facilitates wireless connectivity between the system 602 and the “outside world,” via a communications carrier or service provider. Transmissions to and from the radio 672 are conducted under control of the operating system 664. In other words, communications received by the radio 672 may be disseminated to the application programs 650 via the operating system 664, and vice versa.

According to an aspect, the visual indicator 620 is used to provide visual notifications and/or an audio interface 674 is used for producing audible notifications via the audio transducer 625. In the illustrated example, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. According to an aspect, the system 602 further includes a video interface 676 that enables an operation of an on-board camera 630 to record still images, video stream, and the like.

According to an aspect, a mobile computing device 600 implementing the system 602 has additional features or functionality. For example, the mobile computing device 600 includes additional data storage devices (removable and/or non-removable) such as, magnetic disks, optical disks, or tape. Such additional storage is illustrated in FIG. 6B by the non-volatile storage area 668.

According to an aspect, data/information generated or captured by the mobile computing device 600 and stored via the system 602 are stored locally on the mobile computing device 600, as described above. According to another aspect, the data are stored on any number of storage media that are accessible by the device via the radio 672 or via a wired connection between the mobile computing device 600 and a separate computing device associated with the mobile computing device 600, for example, a server computer in a distributed computing network, such as the Internet. As should be appreciated such data/information are accessible via the mobile computing device 600 via the radio 672 or via a distributed computing network. Similarly, according to an aspect, such data/information are readily transferred between computing devices for storage and use according to well-known data/information transfer and storage means, including electronic mail and collaborative data/information sharing systems.

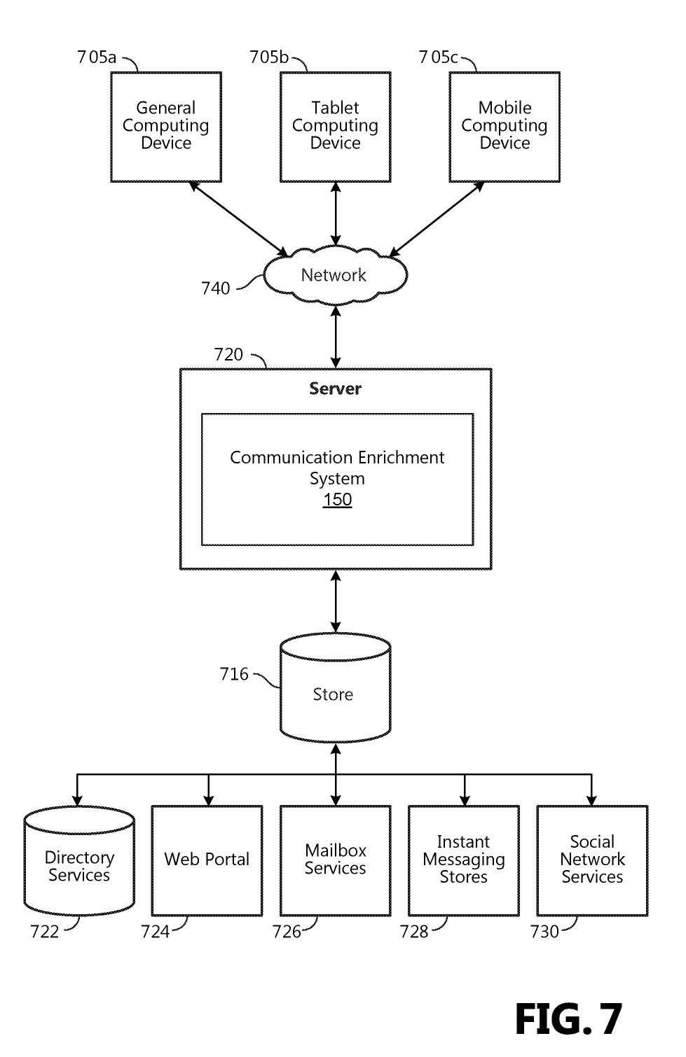

FIG. 7 illustrates one example of the architecture of a system for improving the efficiency of the communication client 120 to visually identify the substance of the communication item and execute/perform any functionality associated with a communication item without opening the communication item. Content developed, interacted with, or edited in association with the communication enrichment system 150 is enabled to be stored in different communication channels or other storage types. For example, various documents may be stored using a directory service 722, a web portal 724, a mailbox service 726, an instant messaging store 728, or a social networking site 730. The communication enrichment system 150 is operative to use any of these types of systems or the like for improving the efficiency of the communication client 120 to visually identify the substance of the communication item and execute/perform any functionality associated with a communication item without opening the communication item, as described herein. According to an aspect, a server 720 provides the communication enrichment system 150 to clients 705a,b,c. As one example, the server 720 is a web server providing the communication enrichment system 150 over the web. The server 720 provides the communication enrichment system 150 over the web to clients 705 through a network 740. By way of example, the client computing device is implemented and embodied in a personal computer 705a, a tablet computing device 705b or a mobile computing device 705c (e.g., a smart phone), or other computing device. Any of these examples of the client computing device are operable to obtain content from the store 716.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

We claim:

1. A method for providing dynamic enrichment of communication items, comprising:
receiving a communication item to display within an application user interface;
extracting enrichment details from the communication item;
querying one or more data sources for enrichment items relating to the enrichment details;
obtaining an enrichment item relating to the enrichment details, the enrichment item including enriched textual information relating to the communication item; and
modifying the communication item with the enrichment item.

2. The method of claim 1, wherein obtaining the enrichment item including enriched textual information relating to the communication item further comprises using machine learning models to generate the enriched textual information.

3. The method of claim 2, wherein the enriched textual information includes an enriched preview of the communication item.

4. The method of claim 2, wherein the enriched textual information includes an enriched subject of the communication item.

5. The method of claim 1, wherein extracting enrichment details from the communication item further includes parsing the communication item for one or more of: keywords, phrases, links, subject, message body, and contact information.

6. The method of claim 1, wherein extracting enrichment details from the communication item further includes extracting entity information that identifies an intent, communication type, or organization.

7. The method of claim 1, further comprising monitoring the enrichment item for changes.

8. The method of claim 7, wherein monitoring the enrichment item for changes further comprises monitoring the enrichment details, communication items, or the enrichment items to determine whether a change has occurred.

9. The method of claim 7, wherein a change occurs when the context relating to the communication item changed.

10. The method of claim 7, further comprising providing real-time status updates relating to the communication item and enrichment items.

11. A computing device for providing automatic enrichment of content with contextually relevant information, comprising:
a processing unit; and
a memory, including computer readable instructions, which when executed by the processing unit is operable to:
receive a communication item to display within an application user interface;
extract enrichment details from the communication item;
query one or more data sources for enrichment items relating to the enrichment details;
obtain enriched textual information relating to the communication item and responsive to the enrichment details;
modify the communication item with an enriched textual information; and
monitor the enriched textual information for changes.

12. The computing device of claim 11, wherein the enriched textual information is generated using machine learning models.

13. The computing device of claim 12, wherein the enriched textual information includes an enriched preview of the communication item.

14. The computing device of claim 12, wherein the enriched textual information includes an enriched subject of the communication item.

15. The computing device of claim 11, wherein the processing unit is further operable to extract enrichment details from the communication item further includes parsing the communication item for one or more of: keywords, phrases, links, subject, message body, and contact information.

16. The computing device of claim 11, wherein the processing unit is further operable to extract enrichment details from the communication item further includes extracting entity information that identifies an intent, communication type, or organization.

17. The computing device of claim 11, wherein the processing unit is further operable to monitor the enriched textual information for changes further comprises monitoring the enrichment details, communication items, or the enriched textual information to determine whether a change has occurred.

18. The computing device of claim 11, wherein a change occurred when the context relating to the communication item changes.

19. The computing device of claim 11, wherein the processing unit is further operable to provide real-time status updates relating to the communication item and enrichment items.

20. A computer readable storage device including computer readable instructions, which when executed by a processing unit is operable to:
receiving a communication item to display within an application user interface;
extracting enrichment details from the communication item;
querying one or more data sources for enrichment items relating to the enrichment details;
obtaining an enrichment item relating to the enrichment details, the enrichment item including enriched textual information relating to the communication item;
modifying the communication item with the enrichment item;
monitoring the enrichment item for changes; and
providing real-time status updates to the enrichment items relating to the communication item.
